(19) United States
(12) Patent Application Publication
(10) Pub. No.: US 2009/0307025 A1
(43) Pub. Date: Dec. 10, 2009

(54) Attrition Warning and Control System

(75) Inventor: Vishwanath Menon, Bangalore (IN)

Correspondence Address: ACCENTURE CHICAGO 28164;BRINKS HOFER GILSON & LIONE, P O BOX 10395, CHICAGO, IL, 60610, US

(73) Assignee: Accenture Global Services GmbH, Schaffhausen (CH)

(21) Appl. No.: 12/135,938

(22) Filed: Jun. 9, 2008

(51) Int. Cl. G06Q 10/00

(52) U.S. Cl. 705/7

(57) ABSTRACT

An attrition warning and control system informs an employer as to the risk of attrition for an employee. The employee is assigned a discrete attrition category. The discrete attrition category is determined from an employee satisfaction behavior. The employee satisfaction behavior may be categorized according to its behavior type. Portal logic executed by the attrition warning and control system generates employee team attrition risk reports for employee teams. The portal logic also builds project team attrition risk reports from the employee team attrition risk reports. Reporting logic executed by the attrition warning and control system delivers the discrete attrition category, employee satisfaction behavior, the employee team attrition risk reports, and the project team attrition risk reports through an authorized connection via a communication interface.

### BACKGROUND

1. Technical Field

This application relates to an employee monitoring system, and in particular, an attrition warning and control system that indicates when an employee is at risk of leaving the employer.

2. Related Art

Employees are a precious investment for an employer. For example, when an employer hires an employee, an employer typically spends a significant amount of time and money in training the employee. In other situations, an employee may be trained to perform a specialized task such that the employer cannot afford to train another employee to perform. Other times, an employee may grant access privileges to knowledge about the employer that would otherwise be confidential. In yet another situation, an employer may have so many projects that the employer cannot afford to lose any one employee. Hence, employees are a significant part of an employer's business and investment.

However, there is a degree of uncertainty and unpredictability whether an employee will continue working for an employer. For example, an employee may desire to pursue other or alternative goals in addition to the jobs given to them by employers. Sometimes the employee goals and the employee's position at an employer conflict, which may result in the employee leaving the employer. Because there is an enormous cost associated with finding, interviewing, hiring, and training new employees, employers generally prefer that employees stay with the employer as long as the employee can perform their duties.

Rather than have an employee leave unexpectedly, employers would prefer to know in advance when an employee plans on leaving. The employer also wants to know when an employee is not happy with their job, so that the employer can help the employee. However, there are a number of variables involved in determining when an employee plans on leaving an employer or are dissatisfied with their job. Moreover, when an employer has a large number of employees, determining which employees plan on leaving can be challenging.

### SUMMARY

Determining which employees plan on leaving may include determining a discrete attrition category for the employee. The discrete attrition category may be based on employee satisfaction behavior a manager or other project leader receives from an employee. The manager may then determine the discrete attrition category for the employee based on the employee satisfaction behavior. Moreover, after receiving employee satisfaction behaviors from several employees, a manager may prepare attrition risk reports, such as employee team attrition risk reports, that include the employees and their associated discrete attrition categories. The manager may also prepare project team attrition risk reports from the employee team attrition risk reports. However, the techniques employed by the manager in receiving the employee satisfaction behavior, determining the discrete attrition category, and preparing the attrition risk reports may be incorporated into hardware and software systems.

For example, an attrition warning and control system may include reporting logic and portal logic for preparing the attrition risk reports that assist in determining whether an employee is at risk of attrition. The attrition warning and control system may also include a processor and a communication interface coupled to the processor that receives employee input corresponding to employee satisfaction behavior. The report delivery logic may also deliver the attrition risk reports through the communication interface.

The memory may also include employee satisfaction indicator sets that correspond to employee satisfaction behavior types. The employee satisfaction indicator sets may describe the various types of behavior that employees may exhibit. For example, the employee satisfaction indicator sets may include an emotional employee satisfaction indicator set that includes emotional behaviors exhibited by an employee, a physical employee satisfaction indicator set that includes physical behaviors exhibited by an employee, and a general employee satisfaction indicator set that includes behaviors that may be emotional, physical, or both. The general employee satisfaction indicator set may also (or only) include behaviors that are not emotional or physical. The employee satisfaction behavior sets may also include other types of employee satisfaction indicator sets.

To determine whether an employee is at risk of attrition, the attrition warning and control system may receive employee input for an employee that describes the employee's satisfaction behavior. The employee's satisfaction behavior describes a behavior exhibited by the employee. The employee input may then be evaluated to determine the employee's satisfaction behavior type. The employee's satisfaction behavior type may be emotional, physical, neither, or both. Based on the employee's behavior, the employee's behavior type, or other combinations, a discrete attrition category may be determined for the employee. The determined discrete attrition category employee represents the risk of attrition for the employee. A manager, team leader, project leader, or other entity may determine the discrete attrition category for the employee. The discrete attrition category for the employee may then be added to various attrition risk reports, such as the employee team attrition risk reports, the project attrition risk report, or other reports.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows one example of an attrition warning and control system.

FIG. 2 shows one example of employee satisfaction behavior sets.

FIG. 3 shows one example of discrete attrition risk categories evaluated based on an employee satisfaction behavior.

FIG. 4 shows one example of discrete attrition risk categories that include a highest risk level, a medium risk level, and a lowest risk level.

FIG. 5 shows one example of employee team attrition risk reports.

FIG. 6 shows one example of a project attrition risk report that includes employee team attrition risk reports.

FIG. 7 shows another example of a project attrition risk report.

FIG. 8 shows an example of a graphical project attrition risk report.

FIG. 9 shows logic flow for monitoring employee attrition risk.

FIG. 10 shows logic flow for monitoring employee attrition risk continued from FIG. 9.

### DETAILED DESCRIPTION

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of the systems and methods consistent with the attrition warning and control system and method may be stored on, distributed across, or read from other machine-readable media.

The attrition warning and control system may be implemented in secondary storage devices such as hard disks, floppy disks, and CD-ROMs; as part of a signal received from a network; or in other forms of ROM or RAM. The d attrition warning and control system may be implemented in any type of software or hardware, either currently known or later developed.

Furthermore, although specific components of the attrition warning and control system will be described, methods, systems, and articles of manufacture consistent with the attrition warning and control system may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processor.

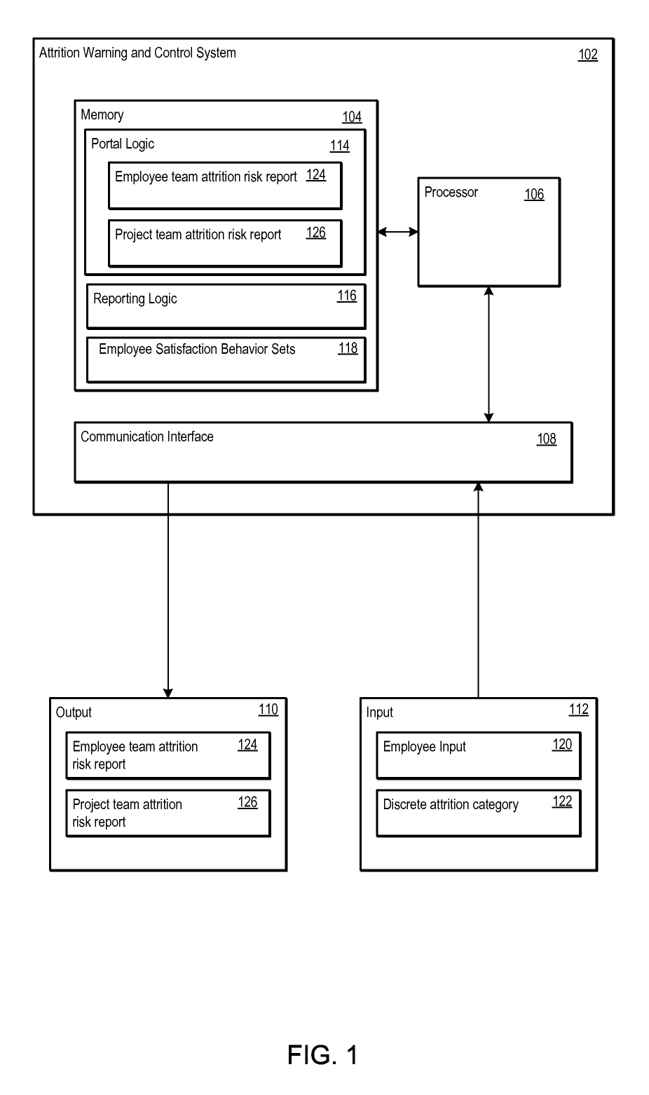

FIG. 1 shows one example of an attrition warning and control system 102. The attrition warning and control system 102 includes a memory 104, a processor 106, and a communication interface 108. The memory 104 and the processor 106 receive inputs 112 and transmit outputs 110 via the communication interface 108.

The memory 104 stores portal logic 114, reporting logic 116, and employee satisfaction behavior sets 118. The processor 106 executes the portal logic 114 and the reporting logic 116.

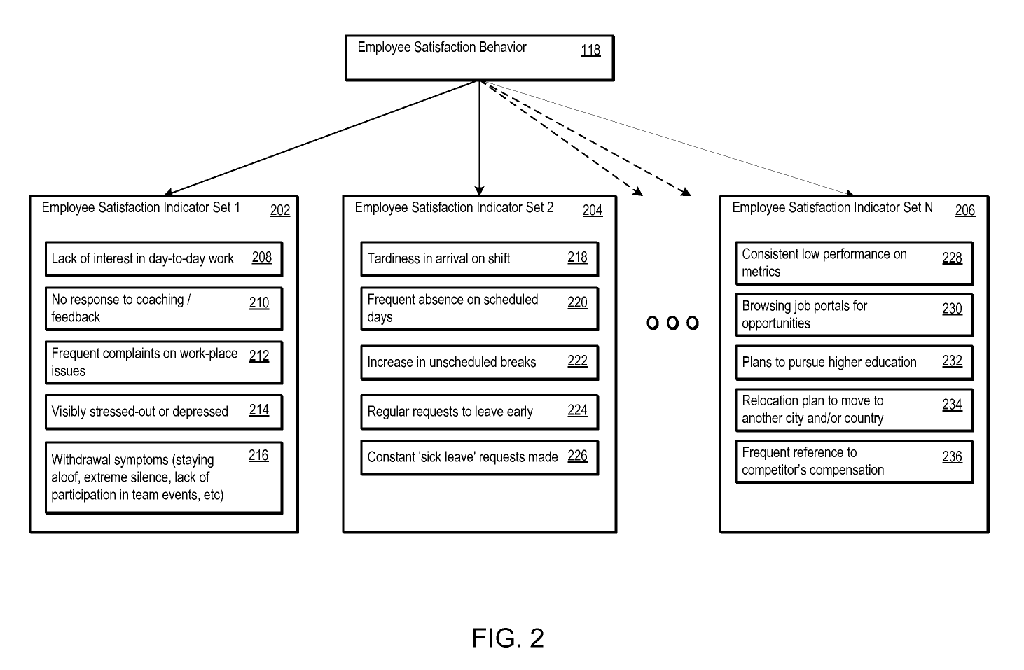

As explained below with reference to FIG. 2, the employee satisfaction behavior sets 118 generally categorize different types of employee behaviors. In one implementation, the employee satisfaction behavior sets 118 include an emotional indicator set and a physical indicator set for categorizing employee behaviors. In an alternative implementation, the employee satisfaction behavior sets 118 includes a general indicator set for categorizing employee behavior that is not exclusively an emotional behavior or is not exclusively a physical behavior. The general indicator set may also categorize employee behavior that is included in the emotional indicator set and the physical indicator set. The employee satisfaction behavior sets 118 may also include different employee behavior indicator sets other than the emotional indicator set, the physical indicator set, and the general indicator set.

An employee's behavior may be categorized according to a behavior type of the employee satisfaction behavior sets 118. In one implementation, the attrition warning and control system 102 receives employee input 120 that corresponds to the employee's behavior from inputs 112. The inputs 112 may be provided by any type of input device including a keyboard, mouse, another computer or system, a piece of hardware such as hard drive or memory, or any other type of device that may be used for input. The inputs 112 may also be provided by the employer, a manager, an employee, a computer system, or any other entity.

The employee input 120 may be provided by an employee, an employer, a project leader, a team leader, an automated system, or any other type of entity operable to provide the employee input 120. The employee input 120 may be provided through an authorized connection with the attrition warning and control system 102. The memory 104 may also store the employee input 120.

In one implementation, the portal logic 114 is operable to accept one or more authorized connections through the communication interface 108. The authorized connections may be any type of connection including wired connections, wireless connections, intranet or extranet connections, or any other type of connection now known or later developed.

After receiving the employee input 120, an employer or other entity may evaluate the employee input 120 to determine a discrete attrition category for the employee. Evaluating the employee input 120 may include determining an employee satisfaction behavior and an employee satisfaction behavior type from the employee input 120. Evaluating the employee input 120 may also include determining the discrete attrition category for the employee based on the employee satisfaction behavior and the employee satisfaction behavior type.

The attrition warning and control system 102 may be configured with multiple discrete attrition categories. In one implementation, the attrition warning and control system 102 is configured with three discrete attrition categories: a high-risk category that indicates that there is a high risk of attrition for the employee; a medium-risk category that indicates that there is a medium risk of attrition for the employee that is less than the high risk; and a low-risk category that indicates that there is a low risk of attrition for the employee that is less than the medium risk.

Evaluating the employee input 120 to determine the discrete attrition category for the employee may be a subjective, objective, or a combination of subjective and objective evaluation. For example, in one implementation, the employer may have discretion in determining whether a particular behavior represents a low, medium or high risk of attrition. An example of subjectively determining a discrete attrition risk category is determining whether an employee satisfaction behavior indicates that the employee complains “frequently” or “appears distracted.” If the employee complains “frequently” or “appears distracted,” the employee may be assigned a discrete attrition category that represent a high risk of attrition.

In another implementation, objective standards may determine the discrete attrition category assigned to the employee. For example, the employer may refer to a chart, graph, or other knowledge base to objectively determine the discrete attrition category assigned to the employee. An example of objectively determining a discrete attrition category is determining whether the employee satisfaction behavior indicates that the employee has worked less than 5 hours a day. The employer may consult an objective rule that states where an employee works less than 5 hours a day, the employee should be assigned a discrete attrition category representing a high risk of attrition.

While the examples of employee input 120 above illustrate evaluating a single employee satisfaction behavior to determine a discrete attrition category, the discrete attrition category may be determined by evaluating more than one employee satisfaction behavior. For example, the employee input 120 may include a first employee satisfaction behavior of frequent complaints, a second employee satisfaction behavior of tardiness in arrival to his or her shift, and a third employee satisfaction behavior of working more than 50 hours a week. In this example, the employer may determine the discrete attrition category for the employee based on a subjective or objective evaluation of the three employee satisfaction behaviors. In other examples, additional or fewer employee satisfaction behaviors are used to determine a discrete attrition category for the employee.

Moreover, the discrete attrition category for the employee may be determined based on an employee satisfaction behavior type. In one implementation, an employee satisfaction behavior type is assigned a weighting value for objectively determining a discrete attrition category for an employee. In another implementation, an employee satisfaction behavior type is subjectively determined as having a higher risk of attrition or a lower risk of attrition. For example, an employee satisfaction behavior that is an emotional employee satisfaction behavior may be determined as having a higher risk of attrition than an employee satisfaction behavior that is a physical emotional employee satisfaction behavior type. Hence, the discrete attrition category for the employee may be determined based on the employee satisfaction behavior, the employee satisfaction behavior type, or a combination of the two.

In yet a further implementation, the attrition warning and control system 102 may receive the determined discrete attrition category 122 included with inputs 112. The determined discrete attrition category 122 may be previously determined by the employer or other entity, such as a project leader, team leader, the employee, or a combination of entities. The received discrete attrition category 122 may be stored in the memory 104. As the received discrete attrition category 122 is stored in memory 104, the received discrete attrition category 116 may be added to employee team attrition risk reports 124, the project team attrition risk reports 126, or any other report.

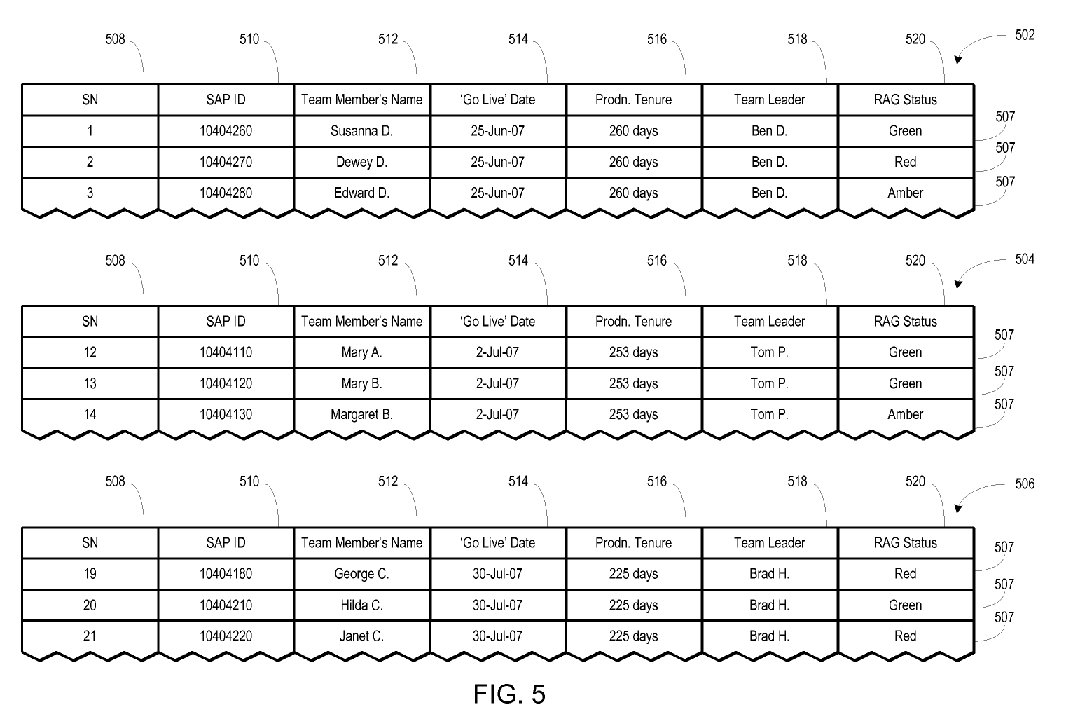

Since an employer often has multiple employees, the portal logic 114 is configured to generate an employee team attrition risk reports of team-wide attrition 124. The employee team attrition risk reports 124 may each comprise one or more discrete attrition categories for a corresponding number of employees. For example, employees working together as a team to complete a project may each have a determined discrete attrition category in the employee team attrition risk report. The team attrition risk reports 124 are further explained below with reference to FIG. 5.

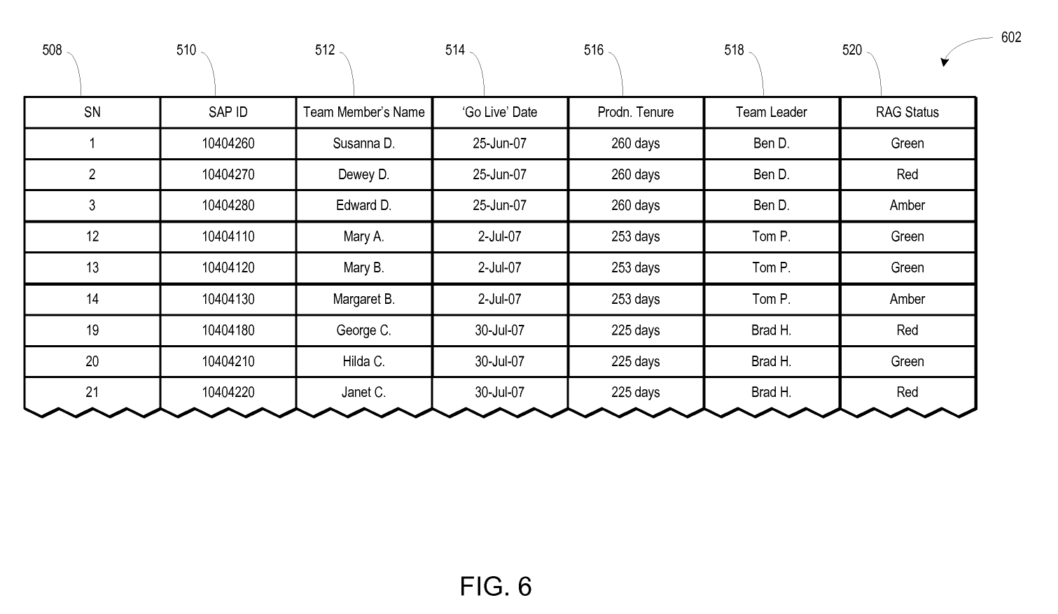

In addition to employee team attrition risk reports 124, the portal logic 114 may be further operable to build a project attrition risk report of project-wide attrition 126. The project attrition risk reports 126 may include the team attrition risk reports 124. The project attrition risk reports 126 summarize the risk of attrition for employees associated with a project. The project attrition risk reports 126 are further explained below with reference to FIGS. 6-8.

The reporting logic 116 is operable to output the employee team attrition reports 118 and the project team attrition reports 126 as outputs 110. Outputs 110 may also include other outputs, such as the discrete attrition category 116 for an employee, the employee input 120, the employee satisfaction behavior, the employee satisfaction behavior type, the employee satisfaction behavior sets 118, or any other elements of the attrition warning and control system 102. The outputs 110 may further include outputs for more than one employee. The outputs 110 may be output to any output device or system, including, and not limited to, display devices, printing devices, memory devices, other computer systems, or any other output device now known or later developed.

FIG. 2 shows one example of the employee satisfaction behavior sets 118. In the example of FIG. 2, the employee satisfaction behavior sets 118 include a first employee satisfaction indicator set 202, a second employee satisfaction indicator set 204, and a Nth employee satisfaction indicator set 206, where N is any integer. In general, the employee satisfaction behavior sets 118 may include any number N of employee satisfaction behavior sets.

Each of the employee satisfaction indicator sets 202-206 represent an employee satisfaction behavior type. In general, an employee satisfaction behavior type is the type of behavior exhibited by the employee. An employee satisfaction behavior type may be emotional, physical, unemotional, non-physical, any other type of behavior, or any combination of behavior. The employee satisfaction behavior sets 202-206 categorize employee satisfaction behaviors according to their corresponding employee satisfaction behavior type. For example, the employee satisfaction indicator set 202 includes emotional behaviors and the employee satisfaction indicator set 204 includes physical behaviors. The employee satisfaction indicator set 206 may categorize additional employee behaviors. The employee satisfaction behavior indicator set 206 may also categorize employee behaviors as a general employee behavior type.

Examples of emotional behaviors 208-216 are categorized in the emotional employee behavior indicator set 202. The emotional behaviors 208-216 may comprise both subjective and objective behaviors. The emotional behaviors 208-216 include a lack of interest in day-to-day work, no or little response to coaching and/or feedback, frequent complaints on work-place issues, visibly stressed-out or depressed, and general withdrawal symptoms. The examples of emotional behaviors 208-216 are not meant to be exhaustive and the emotional employee indicator set 202 may include alternative emotional employee behaviors other than those shown in FIG. 2.

Examples of physical behaviors 218-226 are categorized in the physical employee emotional indicator set 204. The physical behaviors 218-226 comprise both subject and objective behaviors. The physical behaviors 218-226 include tardiness in arrival on shift, frequent absence on scheduled days, increase in unscheduled breaks, regular requests to leave early, and constant ‘sick leave’ requests. The examples of physical behaviors 218-216 are not meant to be exhaustive and the physical employee indicator set 202 may include alternative physical employee behaviors other than those shown in FIG. 2.

Examples of general behaviors 228-236 are categorized in the general employee satisfaction indicator set 206. The general behaviors 228-236 may comprise both subjective and objective behaviors. The general behaviors 228-236 include consistent low performance on metrics, browsing job portals for opportunities, plans to pursue higher education, a relocation plan to move to another city and/or country, and frequent reference to a competitor's compensation. The examples of general behaviors 228-236 are not meant to be exhaustive and the general employee indicator set 206 may include alternative general employee behaviors other than those shown in FIG. 2.

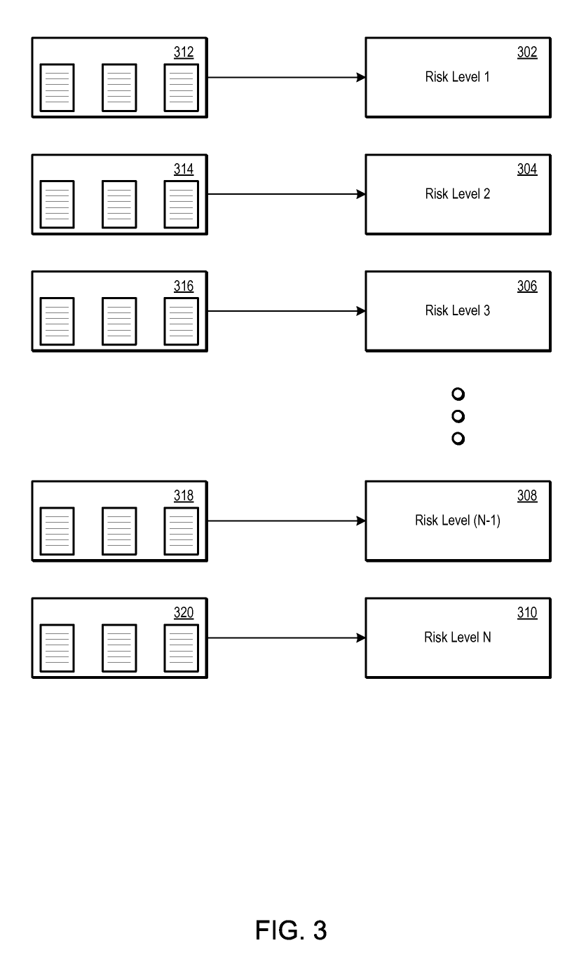

With reference to FIG. 1, the employee input 120 may correspond to one or more of the behaviors 228-236 shown in FIG. 2. Based on the employee input 120, the employee behavior type of the employee behavior corresponding to the employee input 120 may be determined. As explained with reference to FIG. 3, the employee behavior and the employee behavior type may be evaluated to determined the discrete attrition category for the employee.

FIG. 3 shows one example of discrete attrition risk categories 302-310 evaluated based on an employee satisfaction behaviors 312-320. The attrition warning and control system 102 may have any number N of discrete attrition risk categories 302-310. The discrete attrition risk categories 302-310 represent the spectrum of attrition risk for the employees of an employer.

The discrete attrition risk categories 302-310 may include a first risk level 302 representing the lowest risk of attrition, a second risk level 304 representing the second lowest risk of attrition, a third risk level 306 representing the third lowest risk of attrition, an N−1 risk level 308 representing the second greatest risk of attrition, and an N risk level 310 representing the greatest risk of attrition. In alternative arrangements, the attrition warning and control system 102 may have fewer or additional discrete attrition categories.

The discrete attrition risk categories 302-310 are evaluated based on provided employee satisfaction behaviors 312-320. Each of the provided employee satisfaction behaviors 312-320 may include more than one employee satisfaction behavior and more than one type of employee satisfaction behavior type. The evaluated discrete attrition category for each employee may vary depending on the provided employee satisfaction behavior. In addition, a previously determined evaluated discrete attrition category may change for an individual employee where additional or alternative employee satisfaction behavior is provided.

The evaluations of the provided employee satisfaction behaviors 312-320 may be subjective, objective, or both subjective and objective. For subjective evaluations, the employer may rely on past experiences with other employees to evaluate the provided employee satisfaction behavior. For example, with reference to FIG. 2, the provided employee satisfaction behavior may correspond to the employee satisfaction behavior 224 of regular requests to leave early. The employer may determine that the employee satisfaction behavior does not represent regular requests to leave early, such as no requests to leave early or few requests to leave early. Accordingly, the employer may evaluate the discrete attrition risk category for the employee as a low risk of attrition because the employee has few requests to leave early. However, additional employee satisfaction behavior, such as withdrawal symptoms or frequent reference to a competitor's compensation may increase or decrease the previously determined discrete attrition risk category.

For objective evaluations, the employer may use a knowledge base, database, or other information to evaluate the employee satisfaction behavior. In one implementation, the objective evaluations include thresholds that measure whether an employee satisfaction behavior indicates a risk of attrition. For example, with reference to FIG. 2, the provided employee satisfaction behavior may correspond to consistent low performance on metrics and increase in unscheduled breaks. A database or other repository may have data stating that a 10% increase in unscheduled breaks is a greater risk of attrition but that a 2% decrease in performance on metrics is a low risk of attrition.

Although the employee satisfaction behaviors indicate negative attributes, the employee satisfaction behaviors may be positive attributes, negative attributes, or a combination of positive and negative attributes. The employee input 120 may also be positive, negative, or a combination. The employee satisfaction behaviors and the employee input may also be neutral and be neither positive nor negative. An example of a neutral behavior may be an employee satisfaction behavior corresponding to a change in working late on Tuesdays to working late on Wednesdays. The positive, negative, or neutral employee satisfaction behaviors may be categorized in any of the employee satisfaction indicator sets 202-206.

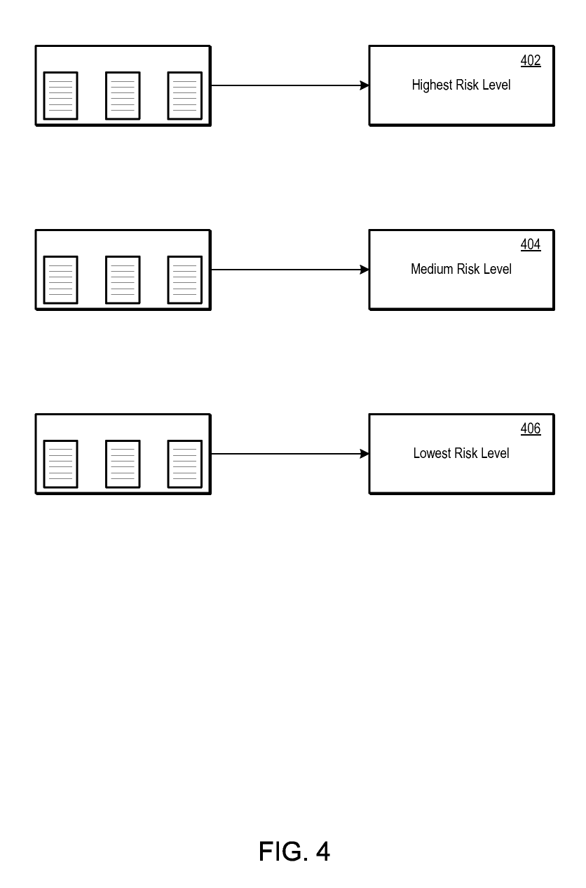

FIG. 4 shows one example of discrete attrition risk categories 402-406 that include a highest risk level 402, a medium risk level 404, and a lowest risk level 406. The highest risk level 402 represents a high-risk category that indicates that there is a high risk of attrition for the employee. The medium risk level 404 represents a medium-risk category that indicates that there is a medium risk of attrition for the employee that is less than the high risk. The low risk level 406 represents a low-risk category that indicates that there is a low risk of attrition for the employee that is less than the medium risk.

FIG. 5 shows one example of employee team attrition risk reports 502-506. The employee team attrition risk reports 502-506 may be included in the employee team attrition risk reports 124 stored by the memory 104.

In general, an employer assigns several employees to a project. If the project has multiple features, individual employees may be assigned to teams to complete the features of the project. The employee teams generally have a team leader and team members. The employee team attrition risk reports 502-506 are examples of employee team attrition risk reports for employees working in teams to complete a project.

Referring to FIG. 1, the portal logic 114 may be configured to generate the employee team attrition risk reports 502-506 of team-wide attrition risks. The employee team attrition risk reports 502-506 include employee rows 507, where each employee row 507 corresponds to an employee of the team. In one implementation, the employee rows 507 include data fields 508-520. The data fields 508-520 include an SN field 508 that represents a randomly assigned serial number of an employee, an SAP ID field 510 that represents an internal employee identification number, a team member name field 512, a live date field 514, a tenure field 516, a team leader field 518, and a discrete attrition risk category field 520. The employee rows 507 may include alternative or additional data fields other than data fields 508-520.

The SN field 508 stores an employee row identifier that identifies the row of the team attrition risk report on which the employee row 507 appears. The SAP ID field 510 stores an employee identifier that identifies the employee for the corresponding employee row 507. The SAP ID field 510 may store a unique identifier for each of the employees. The team member name field 512 stores an identifier that represents the employee name. The live date field 514 identifies a date on which the assigned project is scheduled to be delivered or activated. The tenure field 516 stores a time measurement that indicates the duration of time an employee has worked in a production environment as on the date when the report is generated. The time measurement of the tenure field 516 may be measured in days, hours, minutes, a specific calendar day, or any other measurement of time now known or later developed.

In one implementation, the time measurement from the tenure field 516 may be used to analyze whether the employer is losing experienced employees or whether the employer is losing relatively new employees who are still adapting to the employer, In general, losing experienced employees represents a bigger risk for the employer. The measurement provided by the tenure field 516 may be used to conduct further root cause analysis and for developing plans to address the loss of the employees. Developing plans to address the loss of employees may include developing plans to address the employee loss for the type of employees as indicated by the tenure field 516. In general, an employee that has gained a lot of knowledge has a bigger impact than an employee that has not gained a lot of knowledge.

The team attrition risk reports 502-506 may also include an expected attrition date that identifies an expected attrition time measurement for an employee to attrite. The expected attrition time measurement for the employee may be calculated based on the discrete attrition category of the employee, the employee satisfaction behavior, the employee satisfaction behavior type, or any other data received by the attrition warning and control system 102. In one implementation, each of the discrete attrition categories are associated with an attrition time measurement that represents the number of expected calendar days before the employee leaves the employer. For example, a high-risk discrete attrition category may be associated with an attrition time measurement of 30 days, a medium-risk discrete attrition category may be associated with an attrition time measurement of 30-60 days, and a low-risk discrete attrition category may be associated with an attrition time measurement of greater than 60 days. In this implementation, an employee assigned a high-risk discrete attrition category would indicate that the employee is at risk of attrition within 30 days. Similarly, an employee assigned a medium-risk discrete attrition category would indicate that the employee is at risk of attrition within 30-60 days, and an employee assigned a low-risk discrete attrition category would indicate that the employee is not at risk of attrition for at least 60 days.

In another implementation, each of the discrete attrition categories are associated with an attrition time measurement that represents a specific calendar day on which the employee is expected to attrite. However, the attrition time measurement may be any measurement of time including hours, minutes, second, years, months, days, weeks, or any other measurement of time now known or later developed.

The team leader field 518 stores a team leader identifier team that identifies a leader of a project team to which the employee is assigned. The discrete attrition category field 520 stores the determined discrete attrition category of the employee.

The discrete attrition category field 520 may store any identifier that identifies the discrete attrition category of the employee. For example, the identifiers may be numbers, letters, colors, or any other type of identifier. In one implementation, the attrition warning and control system 102 maintains three discrete attrition categories, and the risk levels associated with the discrete attrition categories are each assigned color. For example, the assigned colors may include green, where green represents a low risk of attrition, amber, where amber represents a medium risk of attrition, and red, where red represents a high risk of attrition. In the team attrition risk reports 502-506, the color green is represented by the word “Green,” the color red is represented by the word “Red,” and the color amber is represented by the word “Amber.” Accordingly, in the team attrition risk reports 502-506, each of the employees are assigned a color that represents the discrete attrition risk category of the employee.

FIG. 6 shows one example of a project team attrition risk report 602 that includes employee team attrition risk reports 502-506. The portal logic 114 is operable to build the project team attrition risk report 602 from the employee team attrition risk reports 502-506. The project team attrition risk report 602 may be included in the project team attrition risk reports 126 stored by the memory 104. In one implementation, the project team attrition risk report 602 includes the SN field 508, the SAP ID field 510, the team member name field 512, the live date field 514, the tenure field 516, the team leader field 518, and the discrete attrition risk category field 520. The reporting logic 16 is operable to deliver the project team attrition risk report 602 via an authorized connection through the communication interface 108.

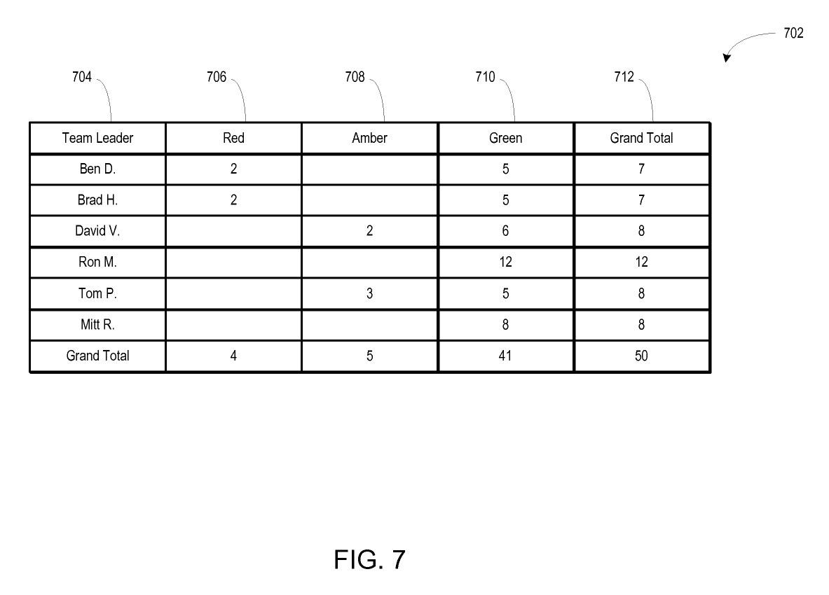

FIG. 7 shows another example of a project team attrition risk report 702. The project team attrition risk report 702 may also be included in the project risk reports 126 stored by the memory 104. The project team attrition risk report 702 includes project team rows that identify project teams. The project team attrition risk report 702 also includes data fields 704-712 for each of the project rows. The data fields 704-712 include a team leader identifier field 704, a high risk count field 706, a medium risk count field 708, a low risk count field 710, and a project team risk count field 712. The project team attrition risk report 702 may also include a risk count summary row that summarizes the employees at risk of attrition for each of the discrete attrition categories of the attrition warning and control system 102.

The team leader identifier field 704 stores a project leader identifier that identifies the project leader for a project team. The project leader identifier may be a unique identifier for each of the project teams. The high risk count field 706 stores a high risk project count that identifies the number of employees on a project team that are assigned a discrete attrition category of a high risk level. The medium risk count field 708 stores a medium risk project count that identifies the number of employees on a project team that are assigned a discrete attrition category of a medium risk level. The low risk count field 710 stores a low risk project count that identifies the number of employees on a project team that are assigned a discrete attrition category of a low risk level.

The data fields 706-710 correspond to the number of discrete attrition categories of the attrition warning and control system 102. In the implementation shown in FIG. 7, the attrition warning and control system 102 includes three discrete attrition categories. However, the attrition warning and control system 102 may include additional or fewer discrete attrition categories than those shown in FIG. 7. For example, the attrition warning and control system 102 may include 2 discrete attrition categories, 50 discrete attrition categories, 400 discrete attrition categories, or any number of discrete attrition categories.

The project team risk count field 712 stores a project team risk count that identifies the number of employees on a project team that are at risk of attrition. The project team risk count field 712 may include any employee that is at risk of attrition or may include employees whose risk of attrition meets or exceeds a given threshold. For example, the risk count field 712 may include employees whose risk of attrition is a medium risk and a high risk, but not a low risk of attrition. In an alternative example, the project team risk count may identify employees whose risk of attrition is below a given threshold. Hence, the project team risk count may be configured according to any set of criteria.

The risk count summary row summarizes the employees at risk of attrition for each of the discrete attrition categories of the attrition warning and control system 102. As shown in FIG. 7, the risk count summary row identifies that there are four employees at a high risk of attrition, 5 employees at a medium risk of attrition, and 41 employees at a low risk of attrition. The risk count summary row also summarizes the total number of employees at risk of attrition. However, like the project team risk count field 712, the risk count summary row may identify employees whose risk of attrition is below a given threshold, meets a given threshold, or exceeds a given threshold. Accordingly, the risk count summary row may be configured according to any set of criteria.

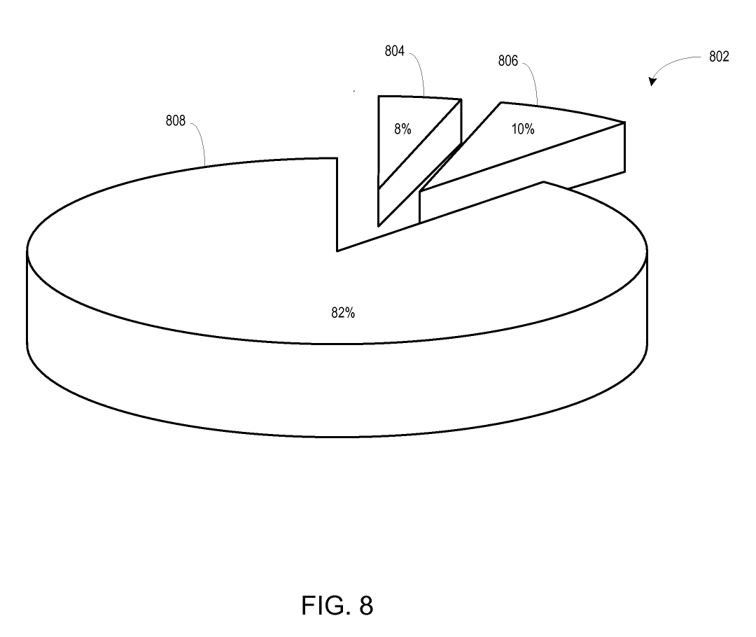

FIG. 8 shows an example of a graphical project team attrition risk report 802. The graphical project team attrition report 802 summarizes the employees at risk of attrition shown in the project team attrition risk reports 602 and 702. The portal logic 114 may be operable to build the graphical project team attrition risk report 802 from the employee team attrition risk reports 502-506, the project team attrition risk reports 602 and 702, the discrete attrition category 122, the employee input 120, or any other data provided or stored by the attrition warning and control system 102. The graphical project team attrition risk report 802 may be stored as part of the project team attrition risk reports 126 in the memory 104.

In one implementation, the graphical project team attrition risk report 802 displays a pie chart as a graphical representation of the employees at risk of attrition. However, the graphical project team attrition risk report 802 may include other or alternative graphical elements including bars, lines, geometric symbols, alphanumeric characters, or any other graphical element now known or later developed.

The graphical project team attrition risk report 802 comprises graphical components that illustrate the employees at risk of attrition for the discrete attrition categories of the attrition warning and control system 102. In the example shown in FIG. 8, there are three discrete attrition categories assigned to the employees: a low-risk discrete attrition category, a medium-risk discrete attrition category, and a high-risk discrete attrition category. Accordingly, the graphical project team attrition risk report 802 includes a low-risk graphical component 804, a medium-risk graphical component 806, and a high-risk graphical component 808. However, the graphical project team attrition risk report 802 may also include other or alternative graphical components based on the number of discrete attrition categories assigned to the employees, the number of discrete attrition categories assigned to the attrition warning and control system 102, or any other number of discrete attrition categories.

Each of the graphical components of the graphical project team attrition risk report 802 may include a discrete attrition category risk summary for the employees assigned to the particular discrete attrition category. The discrete attrition category risk summary may include a percentage, an employee count, a fractional number, or any other numerical value that summarizes the employees assigned to the particular discrete attrition category. For example, the high-risk graphical component 804 includes a discrete attrition category risk summary that shows that 8% of the project team employees have a high risk of attrition. Similarly, the medium-risk graphical component 806 includes a discrete attrition category risk summary that shows that 10% of the project team employees have a medium risk of attrition, and the low-risk graphical component 808 includes a discrete attrition category risk summary that shows that 82% of the project team employees have a low-risk of attrition. The graphical components 804-808 may also include other discrete attrition category risk summaries other than those shown in FIG. 8.

Referring back to FIG. 1, and in addition to generating the employee team attrition risk reports 124 and the project team attrition risk reports 126, the portal logic 114 may be operable to establish a remote access portal for access to the employee team attrition risk reports 125 and the project team attrition risk reports 126. The remote access portal may be adapted to permit authorized access to any of the reports 126-128, the employee satisfaction behavior sets 118, previously stored employee input 120, previously determined discrete attrition categories 122, or any other data stored or provided by the attrition warning and control system 102. The remote access portal may be implemented as an Internet web site, an intranet web site, as a File Transfer Protocol (“FTP”) server, as a Secure Shell (“SSH”) session, or any other remote access portal now known or later developed. The reporting logic 116 may be operable to deliver the employee team attrition risk reports 124 and the project team attrition risk reports 126 via the remote access portal.

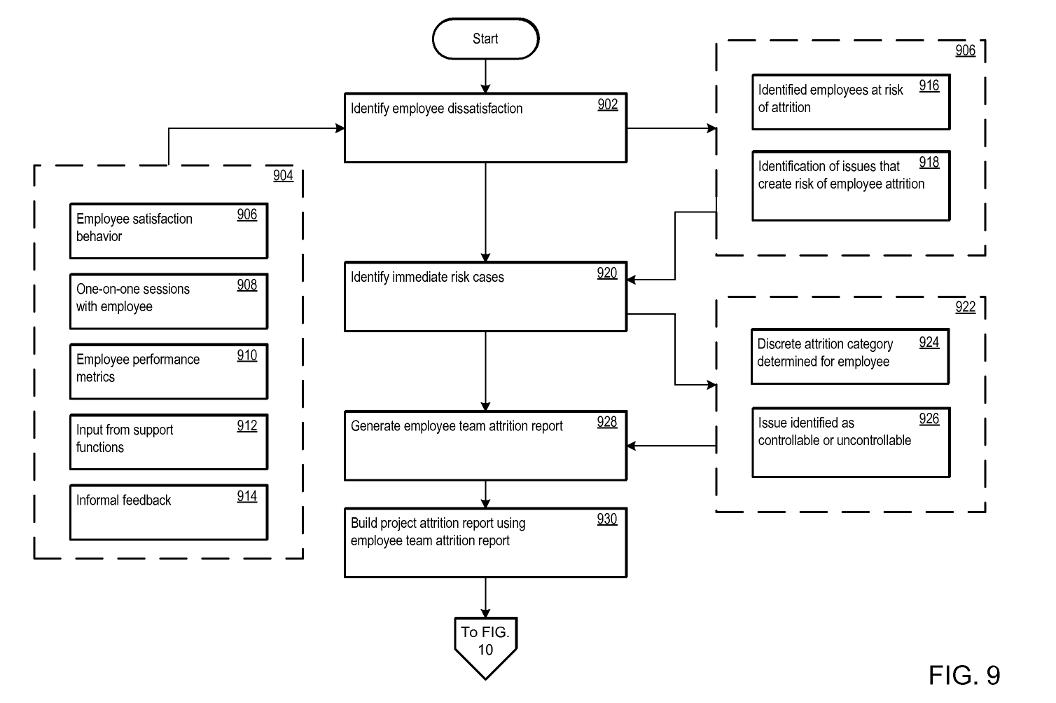

FIG. 9 shows logic flow for monitoring employee attrition risk. The logic flow includes identifying employee dissatisfaction for the employees (902). Identifying employee dissatisfaction may include a number of separate inputs 904. For example, identifying employee dissatisfaction may include receiving employee satisfaction behavior inputs (906), one-on-one sessions conducted with employees (908), receiving employee performance metrics (910), receiving input from support functions (912), and informal feedback (914). The one-on-one sessions conducted with employees may involve questions or other survey information to determine the satisfaction behavior of the employee. The one-on-one sessions may be conducted by the employer, project team leaders, project managers, a computer-assisted survey, or any another entity capable of conducting one-on-one sessions. Receiving input from support functions may include specific documented or verbal feedback about the employee from a training department, a quality control department, a risks & compliance department, a human resources department, or any other department that performs business support functions for an employer. Informal feedback may include receiving input from other employees, from informal conversations with the employee, or other forms of input.

Identifying employee dissatisfaction may also include separate outputs 906. The outputs may include the identified employees at risk of attrition 916 and the issues that the at-risk employees have that lead to the risk of attrition 918. The outputs 906 may also include other information from identifying employee dissatisfaction (902).

The outputs 906 are then used as input information for identifying immediate risk cases (920). Identifying immediate risk cases (920) generally refers to determining the discrete attrition categories for the employees or identifying the employees who are at the most risk of attrition. Identifying immediate risk cases (920) may include determining discrete attrition categories for employees and identifying issues that lead to risks of attrition as controllable or uncontrollable. Accordingly, identifying immediate risk cases (920) may yield outputs 922 such as determined discrete attrition categories for the employees 924 and the issues that lead to the risk of attrition identified as uncontrollable or controllable 926. In general, an issue is controllable when the issue is resolvable and an issue is uncontrollable when the issue is not resolvable. A controllable issue may be resolved by any entity including the employee, the employer, project managers, computer systems, or any other entity capable of resolving the issue.

The outputs 922 may then be used as inputs for generating the employee team attrition risk reports (928). As previously discussed, the portal logic 114 may generate the employee team attrition risk reports from the determined discrete attrition categories assigned to the employees. The portal logic 114 may then build the project team attrition risk reports using the employee team attrition risk reports (930).

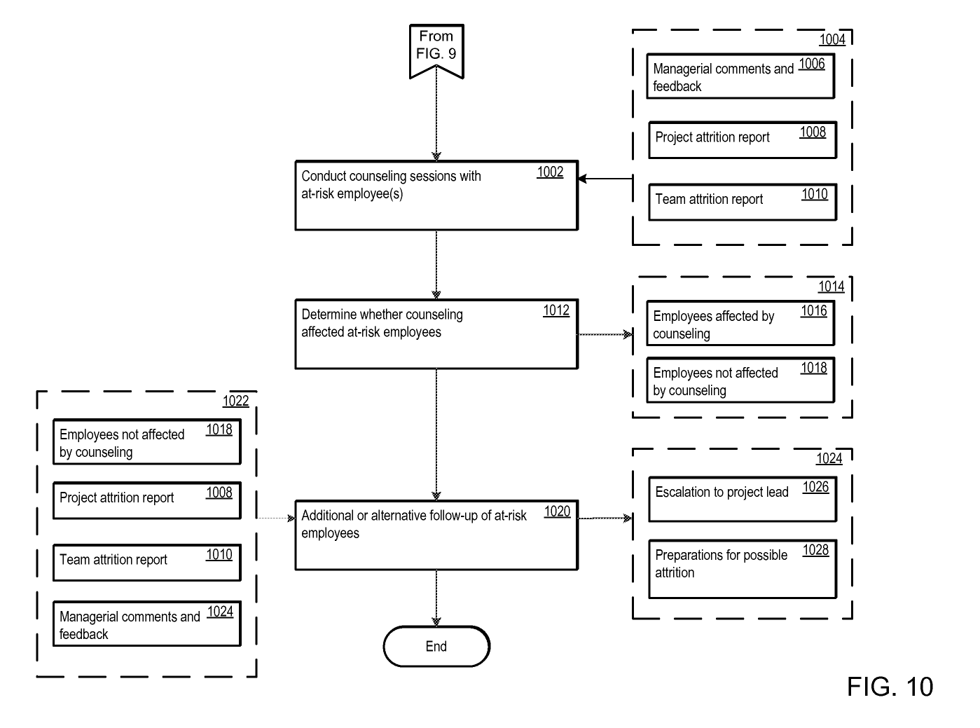

FIG. 10 shows logic flow for monitoring employee attrition risk continued from FIG. 9. After building the employee team attrition risk reports and the project team attrition risk reports, the employer may be contacted or notified as to the employees that are at risk of attrition. Following notification, the employer may conduct one or more counseling sessions with the at-risk employees (1002). The counseling sessions may include various inputs 1004, such as managerial comments and feedback 1006, employee team attrition risk reports 1008, project team attrition risk reports 1008, or other information. The counseling sessions may be conducted by any entity including the employer, operation managers, project managers, or any other entity.

The employer may then determine whether the counseled employees were affected by the counseling (1012). For example, the employer may conduct follow-up counseling sessions or use computer-assisted surveys to assess the employee's satisfaction behavior. Determining whether the counseled employees were affected may yield outputs 1014, such as an identification of employees affected by the counseling and employees not affected by the counseling. The determination of whether employees are affected by the counseling may use subjective criteria, objective criteria, or a combination of subjective and objective criteria.

For employees not affected by counseling, the employer may conduct additional or follow-up counseling sessions with the unaffected employees (1020). Inputs 1022 for the follow-up counseling sessions may include the employees not affected by the previous counseling sessions 1018, the project team attrition reports 1008, the employee team attrition reports 1010, and additional managerial comments and feedback 1024. The follow-up counseling sessions may yield outputs 1024. The outputs 1024 may be further actions for the employer to take or additional results for the employer to review. For example, the outputs 1024 may include an escalation of the at-risk employee to a project lead or other entity 1026. Escalating the at-risk employee may encourage the employee to reconsider the issues that lead to the risk of attrition or help the employer identify the issues that the employee has that lead to the risk of attrition. The outputs 1024 may also include preparations by the employer to prepare for the employee attrition 1028. For example, where the employee is not dissuaded from leaving the employer, the employer may undertake preparations for when the employee leaves. Preparations by the employer may include hiring additional employees, reassigning the tasks assigned to the at-risk employee, or terminating the employee before the employee leaves. The employer may take additional preparations or other actions to prepare for the employee's absence. While FIGS. 9 and 10 may be implemented in whole or in part using logic (e.g., in the system 102), they also may be carried out, in whole or in part, by a manual process.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

I claim:

1. An attrition monitoring method comprising:
categorizing an employee satisfaction behavior into an employee satisfaction behavior set to obtain an employee satisfaction behavior type;
receiving employee input corresponding to the employee satisfaction behavior;
evaluating the employee input and the employee satisfaction behavior type to determine a discrete attrition category selected from:
a high-risk category that indicates that there is a high risk of attrition for the employee;
a medium-risk category that indicates that there is a medium risk of attrition for the employee that is less than the high risk; and
a low-risk category that indicates that there is a low risk of attrition for the employee that is less than the medium risk;
generating an employee team attrition risk report of team-wide attrition comprising the discrete attrition category and a corresponding employee identifier; and
building the employee team attrition risk report into a projection attrition risk report of project-wide attrition.

2. The attrition monitoring method of claim 1, where categorizing the employee satisfaction behavior comprises:
categorizing the employee satisfaction behavior as belonging to an emotional indicator set, a physical indicator set, or both.

3. The attrition monitoring method of claim 1, where:
the employee satisfaction behavior set comprises an emotional indicator set, a physical indicator set, and a general indicator set; and,
categorizing the employee satisfaction behavior comprises:
categorizing the employee satisfaction behavior between the emotional indicator set, the physical indicator set, and the general indicator set.

4. The method of claim 1, where the corresponding employee identifier is a unique employee identifier

5. The method of claim 1, where generating further comprises:
adding a team leader identifier that identifies a leader of a project team into the employee team attrition risk report.

6. The method of claim 1, where generating further comprises:
adding an expected attrition date that identifies an expected attrition time measurement for an employee to attrite into the employee team attrition risk report.

7. The method of claim 6, further comprising:
calculating the expected attrition time measurement based on the discrete attrition category of the employee.

8. The method of claim 1, further comprising:
establishing a remote access portal adapted to permit authorized access to the employee team attrition risk report, the project team attrition risk report, or both.

9. The method of claim 1, further comprising:
initiating execution of portal interface logic operable to:
accept the attrition category; and
perform the generating of the employee team attrition risk report of team-wide attrition.

10. The method of claim 9, where the portal interface logic is further operable to:
perform the building of the employee team attrition risk report into the project team attrition risk report.

11. The method of claim 1, where the employee satisfaction behavior set comprises employee emotional behaviors, employee compensation behaviors, employee job performance behaviors, employee educational behaviors, or any combination thereof.

12. An attrition reporting system comprising:
a processor;
a communication interface coupled to the processor; and
a memory coupled to the processor, the memory comprising:
portal logic executable by the processor and operable to:
accept an authorized connection through the communication interface;
accept a discrete attrition category for an employee through the communication interface, wherein the discrete attrition category comprises a discrete attrition category selected from:
a high-risk category that indicates that there is a high risk of attrition for the employee;
a medium-risk category that indicates that there is a medium risk attrition for the employee that is less than the high-risk category; and
a low-risk category that indicates that there is a low risk of attrition for the employee that is less than the medium-risk category;
generate an employee team attrition risk report of team-wide attrition comprising the discrete attrition category and a corresponding employee identifier; and
build the employee team attrition risk report into a project team attrition risk report of project-wide attrition.

13. The attrition reporting system of claim 12, where:
the memory comprises:
an employee satisfaction behavior set corresponding to an employee satisfaction behavior type; and
the discrete attrition category for the employee is determined based on the employee satisfaction behavior type and an employee input corresponding to an employee satisfaction behavior of the employee satisfaction behavior type.

14. The attrition reporting system of claim 13, where the employee satisfaction behavior set comprises employee emotional behaviors, employee compensation behaviors, employee job performance behaviors, employee educational behaviors, or any combination thereof.

15. The attrition reporting system of claim 13, where the employee satisfaction behavior set comprises an emotional indicator set, a physical indicator set, and a general indicator set.

16. The attrition reporting system of 12, where the corresponding employee identifier is a unique employee identifier

17. The attrition reporting system of 12, where the portal logic is further operable to add a team leader identifier that identifies a leader of a project team into the employee team attrition risk report.

18. The attrition reporting system of claim 12, where the portal logic is further operable to add an expected attrition time measurement that identifies an expected time measurement for an employee to attrite into the employee team attrition risk report.

19. The attrition reporting system of claim 18, where the portal logic is further operable to calculate the expected attrition time measurement based on the discrete attrition category of the employee.

20. The attrition reporting system of claim 12, where:
the memory further comprises:
an employee satisfaction behavior set corresponding to an employee satisfaction behavior type;
an employee input corresponding to an employee satisfaction behavior of the employee satisfaction behavior type;
the employee team attrition risk report of team-wide attrition;
the project team attrition risk report of project-wide attrition; and
reporting logic executable by the processor and operable to deliver the employee input, the employee team attrition risk report, and the project team attrition risk report through the communication interface;
